(19) United States
(12) Patent Application Publication
(10) Pub. No.: US 2022/0005086 A1
(43) Pub. Date: Jan. 6, 2022

(54) PERFORMANCE ASSESSMENT OF DRIVERS

(71) Applicant: ANI TECHNOLOGIES PRIVATE LIMITED, Bengaluru (IN)

(72) Inventor: Jebu Ittiachen, Bengaluru (IN)

(73) Assignee: ANI TECHNOLOGIES PRIVATE LIMITED, Bengaluru (IN)

(21) Appl. No.: 17/190,909

(22) Filed: Mar. 3, 2021

(30) Foreign Application Priority Data
Jul. 6, 2020 (IN) 202041028695

(51) Int. Cl. G06Q 30/02; G06Q 10/06; B60W 40/09

(52) U.S. Cl. CPC G06Q 30/0282; G06Q 10/06398; B60W 2540/30; G06Q 30/0207; B60W 40/09

(57) ABSTRACT

A method and system for performance and behavior assessment of drivers is provided. A plurality of primary signals associated with a driver and a vehicle of the driver is processed to generate a plurality of secondary signals. A driver profile of the driver is generated based on at least the plurality of secondary signals. The driver profile includes at least a plurality of driving parameters and their respective parameter values. A driver score corresponding to the performance and behavior of the driver is determined based on the parameter values. A degree of deviation is determined by comparing the driver score with a baseline threshold value. The driver profile is communicated to the driver. The driver profile includes the driver score and the degree of deviation. The driver profile may further include a set of positive or negative feedback and one or more action items.

### CROSS-RELATED APPLICATIONS

This application claims priority of Indian Non-Provisional Application No. 202041028695, filed Jul. 6, 2020, the contents of which are incorporated herein by reference.

### FIELD

Various embodiments of the disclosure relate generally to performance assessment. More specifically, various embodiments of the disclosure relate to performance assessment of drivers of a ride hailing service provider.

### BACKGROUND

The transportation industry has flourished in recent years whether it be freight, warehousing, logistics, or passenger transportation. Such a widespread industry requires a better fleet management system for efficient and effective operations. For efficient and effective operations, tracking and analyzing vehicle's and driver's performance may be necessary since it can lead to optimization that increases productivity and mitigate risks, which in turn lowers costs of the transportation industry over the long-term. However, the transportation industry being a widely distributed industry that employs thousands of drivers, tracking and analyzing of the driver workforce in such a distributed geography is always complex.

For most people, driving seems to be a habitual and easy task as it tends to be of second nature to perform driving manoeuvres due to daily repetition. However, because of the dynamic nature of various components of various vehicles, geographical conditions, ride demand, and ride supply, driving may become a complex decision-making process. Driving capabilities of a driver of a vehicle depends on an age of the driver, driving experience, physical, emotional and mental state, as well as environmental influences such as a surrounding of the vehicle, weather, traffic, or a time of a day. Lack of the driving capabilities due to any reason may hamper driving performance and lead to accidents that can damage the health and life of individuals and properties. Thus, it is important to measure and assess the driver to check whether the driver is fit to drive the vehicle to meet the real time demand and supply. Such measurement and assessment must take into consideration all such factors that can possibly impact the driving in the real time.

A conventional method for assessing the driver's performance involves analyzing feedback from peers and multiple passengers associated with the driver. However, such feedback is not generally focused on the driver's overall skill level but concentrates more on the reporting of isolated incidents that require further review. Also, most of the time, the feedback is not provided in real-time. Hence, they fail to suggest immediate necessary actions that should be implemented for quick improvement. Also, by communicating such feedback at a later instance, the feedback loses its credibility and hardly impacts on the driver's behavior and integrity.

In light of the foregoing, there exists a need for a technical and reliable solution that overcomes the above-mentioned problems, challenges, and short-comings, and continues to assess the driver's overall performance in the real time that is likely to be more effective and efficient in comparison to the current solutions.

### SUMMARY

Performance assessment of drivers is provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a system environment for performance assessment of drivers, in accordance with an exemplary embodiment of the disclosure;

FIG. 2 is a block diagram that illustrates an application server of the system environment of FIG. 1, in accordance with an exemplary embodiment of the disclosure;

FIG. 3 is a block diagram that illustrates a first notification interface rendered on a customer device of the system environment of FIG. 1, in accordance with an exemplary embodiment of the disclosure;

FIG. 4A is a block diagram that illustrates a second notification interface rendered on a driver device of the system environment of FIG. 1, in accordance with an exemplary embodiment of the disclosure;

FIG. 4B is a block diagram that illustrates a third notification interface rendered on the driver device, in accordance with an exemplary embodiment of the disclosure;

FIG. 5A is a block diagram that illustrates a fourth notification interface rendered on the driver device, in accordance with an exemplary embodiment of the disclosure;

FIG. 5B is a block diagram that illustrates a fifth notification interface rendered on the driver device, in accordance with an exemplary embodiment of the disclosure;

FIGS. 6A and 6B, collectively, is a diagram that illustrates a flow chart of a method for assessing performance of a driver of a vehicle of the system environment of FIG. 1, in accordance with an exemplary embodiment of the disclosure; and

FIG. 7 is a block diagram that illustrates a system architecture of a computer system for assessing the performance of the driver, in accordance with an exemplary embodiment of the disclosure.

### DETAILED DESCRIPTION

Certain embodiments of the disclosure may be found in a disclosed apparatus for performance assessment. Exemplary aspects of the disclosure provide a method and a system for assessing performance of one or more drivers of a ride hailing service provider. The method includes one or more operations that are executed by circuitry of an application server to assess the performance of the one or more drivers and communicate one or more action items to the one or more drivers based on the assessed performance in real time. The circuitry may be configured to receive a plurality of primary signals from a vehicle device of a vehicle and a driver device of a driver associated with the vehicle. The plurality of primary signals may include at least two or more of vehicle dynamics information, vehicle throttle information, brake application information, steering wheel information, vehicle door information, vehicle engine information, in-vehicle communication information, real-time position information, allocation-based call log information, and login and logout information. The circuitry may be further configured to process the plurality of primary signals to generate a plurality of secondary signals. The plurality of secondary signals may include at least two or more of driving pattern information, driver's in-vehicle behavior information, vehicle's performance information, incident information, allocation-based responsiveness information, and customer satisfaction information. The circuitry may be further configured to generate a driver profile of the driver based on at least the plurality of secondary signals. The driver profile may include at least a plurality of driving parameters and their respective parameter values. The circuitry may be further configured to determine a driver score corresponding to performance and behavior of the driver based on the parameter values. The circuitry may be further configured to determine a degree of deviation by comparing the driver score with a baseline threshold value. The circuitry may be further configured to detect a positive or negative deviation in the performance and behavior of the driver based on the degree of deviation. The circuitry may be further configured to communicate the driver profile to the driver. The driver profile may include the driver score and the degree of deviation. The driver profile may further include a set of positive or negative feedback and one or more action items. The set of positive or negative feedback may be generated in real-time based on the positive or negative deviation, respectively. The one or more action items may be associated with the set of positive or negative feedback. Further, each of the one or more action items may be associated with a time duration for completing each of the one or more action items.

In an embodiment, the circuitry may be further configured to receive customer feedback corresponding to the performance and behavior of the driver from a customer device of a customer. The customer feedback may include at least one of one or more comments, a rating, or a multimedia recording. The customer feedback may be received for an ongoing ride or a completed ride associated with the vehicle and the driver. The circuitry may be further configured to normalize the customer feedback based on historical customer feedback associated with the customer. The customer feedback may be normalized to obtain normalized feedback signal indicating at least a degree of severity of the customer feedback. The circuitry may be further configured to update the plurality of secondary signals based on the normalized feedback signal.

In an embodiment, the circuitry may be further configured to determine the baseline threshold value based on at least one of a type of the vehicle, a geographical region in which the driver is driving the vehicle, working hours of the driver, or historical performance and rating of the driver. In an embodiment, the set of positive feedback may be presented to the driver by using a gamified scoring system. In an embodiment, the one or more action items associated with the set of positive feedback may include one or more instructions for advancing to a next score level from a current score level in the gamified scoring system. In an embodiment, each score level may be associated with an offer along with an allotment preference for one or more future rides. In an embodiment, the one or more action items associated with the set of negative feedback may include at least one of one or more warning messages or cool-off periods for future allotments. The one or more action items associated with the set of negative feedback may further include a suspension for retraining. The retraining may include presentation of one or more video tutorials on the driver device, followed by electronic questionnaires that are executable by the driver within the time duration. In an embodiment, the set of positive or negative feedback may be communicated to the driver via a service application running on the driver device, an interactive voice response (IVR) call, or a short message service (SMS).

Various methods and systems of the disclosure facilitate performance assessment of drivers in real time. Based on the assessed performance, driver profiles are generated for the drivers. Each driver profile includes a driver score, a degree of deviation, a set of positive or negative feedback, and one or more action items. Thus, based on the driver profiles, the drivers can evaluate themselves in real time and accordingly plan for their future rides. Also, the one or more actions items associated with the set of positive or negative feedback are presented to each driver in an online manner and these action items must be executed or completed by each driver within a given time duration. This improves the driving skills and enhances the driving behavior which may reduce occurrence of unwanted incidents such as accidents.

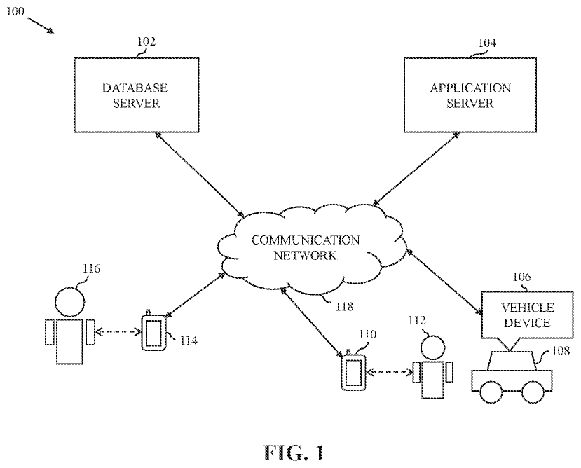

FIG. 1 is a block diagram that illustrates a system environment 100 for performance assessment of drivers, in accordance with an exemplary embodiment of the disclosure. The system environment 100 includes circuitry such as a database server 102, an application server 104, a vehicle device 106 of a vehicle 108, a driver device 110 of a driver 112 of the vehicle 108, and a customer device 114 of a customer 116. The database server 102, the application server 104, the vehicle device 106, the driver device 110, and the customer device 114 may be communicatively coupled to each other via a communication network 118.

The database server 102 may include suitable logic, circuitry, interfaces, and/or code, executable by the circuitry, that may be configured to perform one or more operations, such as receiving, storing, processing, and transmitting queries, signals, messages, data, or content. The database server 102 may be a data management and storage computing device that is communicatively coupled to the application server 104, the vehicle device 106, the driver device 110, and the customer device 114 via the communication network 118 to perform the one or more operations. Examples of the database server 102 may include, but are not limited to, a personal computer, a laptop, or a network of computer systems.

In an embodiment, the database server 102 may be configured to manage and store customer information of each customer (such as the customer 116), driver information of each driver (such as the driver 112 of the vehicle 108), and vehicle information of each vehicle (such as the vehicle 108). For example, the customer information of each customer may include at least a name, a contact number, or a unique identifier (ID), along with other information pertaining to a customer account of each customer registered with an online ride hailing service provider such as a cab service provider. Further, the driver information of each driver may include at least a name, a driver ID, and a registered vehicle make, along with other information pertaining to a driver account of each driver registered with the cab service provider. Further, the vehicle information of each vehicle may include at least a vehicle type, a vehicle number, a vehicle chassis number, or the like. The online ride hailing service provider may be engaged in receiving one or more booking requests from one or more customer devices of one or more customers, process the one or more booking requests, select one or more available vehicles from a pool of vehicles, and allocate the one or more available vehicles to the one or more customers in an online manner These various operations may be implemented and realized by hosting a cloud server such as the application server 104.

In an embodiment, the database server 102 may be further configured to generate a tabular data structure including one or more rows and columns and store the customer, driver, vehicle, and/or booking information in a structured manner in the tabular data structure. For example, each row of the tabular data structure may be associated with the customer 116 having a unique customer ID, and one or more columns corresponding to each row may indicate the various customer information of the customer 116. Similarly, the driver, vehicle, and/or booking information may be stored in a separate tabular data structure or the same tabular data structure.

In an embodiment, the database server 102 may be further configured to manage and store historical feedback associated with the customers, drivers, and vehicles. For example, the database server 102 may manage and store historical vehicle feedback associated with the vehicle 108, historical driver feedback associated with the driver 112, and historical customer feedback associated with the customer 116. The historical vehicle feedback may be received from at least one of the driver device 110 or the customer device 114. The historical vehicle feedback may indicate travelling experience of at least one of the driver 112 or the customer 116 while travelling in the vehicle 108. The historical driver feedback may be received from the driver device 110. The historical driver feedback may indicate travelling experience (related to communication, behavior, or the like) of the driver 112 while travelling with the customer 116 in the vehicle 108. The historical customer feedback may be received from the customer device 114. The historical customer feedback may indicate travelling experience (related to driving, communication, performance, behavior, or the like) of the customer 116 while travelling with the driver 112 in the vehicle 108.

In an embodiment, the database server 102 may be further configured to manage and store vehicle dynamics information. For example, the vehicle dynamics information of the vehicle 108 may include information such as roll angle, pitch angle, yaw rate, roll rate, pitch rate, lateral and longitudinal velocity, lateral and longitudinal acceleration, tire slip, tire slip rate, and other sensed parameters associated with one or more components of the vehicle 108 during one or more rides (historical or real time rides) with the one or more customers such as the customer 116. The database server 102 may be further configured to manage and store vehicle throttle information. For example, the vehicle throttle information may include information that indicates an amount of fuel or air entering an engine of the vehicle 108 during the one or more rides. The database server 102 may be further configured to manage and store brake application information. For example, the brake application information may include information that indicates one or more instances of application of a brake of the vehicle 108 by the driver 112 during the one or more rides. The database server 102 may be further configured to manage and store steering wheel information. For example, the steering wheel information may include information that indicates a steering angle of a steering wheel of the vehicle 108 that is captured at one or more instances of operation of the steering wheel by the driver 112 of the vehicle 108 during the one or more rides. The steering wheel information may further include information that indicates a degree of unusual steering behavior at the one or more instances of operation of the steering wheel by the driver 112 of the vehicle 108 during the one or more rides. The database server 102 may be further configured to manage and store vehicle door information. For example, the vehicle door information may include information that indicates a locking or unlocking state of one or more doors (such as whether a door is fully closed, partially closed, or not closed at all) of the vehicle 108 during the one or more rides. The database server 102 may be further configured to manage and store vehicle compartment information. For example, the vehicle compartment information may include information that indicates an occupancy status of one or more areas (such as one or more seats) that are designed for the seating of the driver 112 and other customers (such as the customer 116) of the vehicle 108 during the one or more rides. The database server 102 may be further configured to manage and store vehicle engine information. For example, the vehicle engine information may include information that indicates performance, maintenance, fuel consumption, health, and temperature of an engine of the vehicle 108 during the one or more rides. The database server 102 may be further configured to manage and store in-vehicle communication information. For example, the in-vehicle communication information may include information that indicates communication (such as cordial or heated communication) between the driver 112 and other customers (such as the customer 116) of the vehicle 108 during the one or more rides. Such communication may also indicate agreement or disagreement between the driver 112 and other customers (such as the customer 116) for one or more in-vehicle features, functions, or operations associated with the vehicle 108. The database server 102 may be further configured to manage and store position information such as historical or real-time position information. For example, the position information may include information (such as latitude and/or longitude coordinates) that indicates one or more positions of the vehicle 108 in a geographical region at one or more time instances during the one or more rides. The database server 102 may be further configured to manage and store allocation-based call log information. For example, the allocation-based call log information may include information that indicates one or more time instances at which the driver 112 may have called (i.e., dialled-in) other customers (such as the customer 116) based on the allocation of the vehicle 108 to the other customers and before boarding of the vehicle 108 by the other customers. In some embodiments, the allocation-based call log information may include information that indicates whether the driver 112 has actually called (i.e., dialled-in) the other customers (such as the customer 116) based on the allocation of the vehicle 108 to the other customers and before boarding of the vehicle 108 by the other customers. The database server 102 may be further configured to manage and store login and logout information. For example, the login and logout information may include information that indicates a login time and a logout time of the driver 112 on daily basis. The database server 102 may be further configured to manage and store allocation information of the one or more vehicles such as the vehicle 108. The database server 102 may be further configured to manage and store customer feedback information. For example, the customer feedback information may include information that indicates a historical cumulative feedback, rating, comments, or the like for driver 112 received from the one or more customers during the one or more rides. The database server 102 may be further configured to manage and store historical performance and rating of one or more drivers such as the driver 112 and historical performance and rating of the one or more customers such as the customer 116. The database server 102 may be further configured to manage and store a type of one or more vehicles such as the vehicle 108, a geographical region in which the driver 112 is driving the vehicle 108, working hours of the driver 112, historical accidental data associated with the driver 112, or the like. All this information, as described above, may be obtained from one or more sensors installed in each vehicle (such as the vehicle 108), the vehicle device 106, the driver device 110, the customer device 114, or any combination thereof.

In an embodiment, the database server 102 may be further configured to receive one or more queries from the application server 104 via the communication network 118. Each query may be an encrypted message that is decoded by the database server 102 to determine one or more requests for retrieving requisite stored information (such as the vehicle information, the driver information, the customer information, or the like). In response to the received queries, the database server 102 may be configured to retrieve and transmit the requested information to the application server 104 via the communication network 118.

The application server 104 may include suitable logic, circuitry, interfaces, and/or code, executable by the circuitry, that may be configured to perform one or more operations associated with performance assessment of the one or more drivers. The application server 104 may be a computing device, which may include a software framework, that may be configured to create the application server implementation and perform the various operations associated with the performance assessment. The application server 104 may be realized through various web-based technologies, such as, but are not limited to, a Java web-framework, a .NET framework, a professional hypertext pre-processor (PHP) framework, a python framework, or any other web-application framework. The application server 104 may also be realized as a machine-learning model that implements any suitable machine-learning techniques, statistical techniques, or probabilistic techniques. Examples of such techniques may include expert systems, fuzzy logic, support vector machines (SVM), Hidden Markov models (HMMs), greedy search algorithms, rule-based systems, Bayesian models (e.g., Bayesian networks), neural networks, decision tree learning methods, other non-linear training techniques, data fusion, utility-based analytical systems, or the like. Examples of the application server 104 may include, but are not limited to, a personal computer, a laptop, or a network of computer systems.

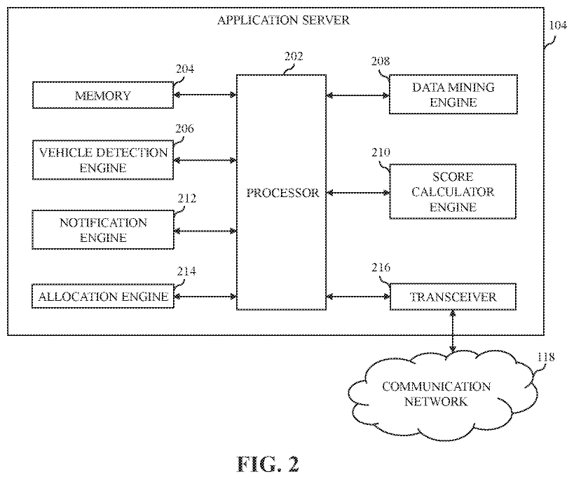

In an embodiment, the application server 104 may be configured to receive a plurality of primary signals from the vehicle device 106 of the vehicle 108 and the driver device 110 of the driver 112 associated with the vehicle 108 via the communication network 118. The plurality of primary signals may include at least one of the vehicle dynamics information, the vehicle throttle information, the brake application information, the steering wheel information, the vehicle door information, the vehicle compartment information, the vehicle engine information, the in-vehicle communication information, the real-time position information, the allocation-based call log information, and the login and logout information. The plurality of primary signals may further include the allocation information, the accident information, the customer feedback information, or the like. The application server 104 may be further configured to process the plurality of primary signals to generate a plurality of secondary signals. The plurality of secondary signals may include at least driving pattern information, driver's in-vehicle behavior information, vehicle's performance information, incident information, allocation-based responsiveness information, booking acceptance information, and customer satisfaction information. The application server 104 may be further configured to generate a driver profile for the driver 112 based on at least the plurality of secondary signals. The driver profile may include at least a plurality of driving parameters and their respective parameter values. The application server 104 may be further configured to determine a driver score for the driver 112. The driver score may correspond to performance and behavior of the driver 112 and may be determined based on the parameter values. The application server 104 may be further configured to determine a degree of deviation. The degree of deviation may be determined by comparing the driver score with a baseline threshold value. The application server 104 may be further configured to detect a positive or negative deviation in the performance and behavior of the driver 112 based on the degree of deviation. The application server 104 may be further configured to communicate the driver profile to the driver 112. The driver profile may include at least one of the driver score, the degree of deviation, a set of positive or negative feedback, and one or more action items. In some embodiments, the driver profile may also include the plurality of driving parameters and their respective parameter values. The set of positive or negative feedback may be generated in real-time based on the positive or negative deviation, respectively. Each of the one or more action items associated with the set of positive or negative feedback may be associated with a time duration for completing each of the one or more action items. Various operations of the application server 104 have been described in detail in conjunction with FIGS. 2, 3, 4A-4B, 5A-5B, and 6A-6B.

The vehicle device 106 may include suitable logic, circuitry, interfaces, and/or code, executable by the circuitry, that may be configured to perform one or more operations associated with the performance assessment of the driver 112 of the vehicle 108. The vehicle device 106 may be configured to run a service application hosted by the application server 104 and control the one or more operations associated with the performance assessment of the driver 112 of the vehicle 108. In an exemplary embodiment, based on the allocation of the vehicle 108 to a ride request (initiated by the customer 116) by the application server 104, the vehicle device 106 may be configured to receive the allocation information from the application server 104 via the communication network 118. Based on the received allocation information, the vehicle device 106 may be utilized by the driver 112 to view a pick-up location and a drop-off location of the customer 116. The vehicle device 106 may be further configured to render an electronic navigation map (hosted by the application server 104) that can be utilized by the driver 112 to navigate between a plurality of locations such as between the pick-up and drop-off locations of the customer 116.

In an embodiment, the vehicle device 106 may be further configured to track real-time position information of the vehicle 108 and communicate this information to the database server 102 or the application server 104 via the communication network 118. In an embodiment, the vehicle device 106 may be further configured to receive the plurality of primary signals from the one or more sensors installed in the vehicle 108 via an in-vehicle communication network such as a Controller Area Network (CAN) bus. The plurality of primary signals may include at least one of the vehicle dynamics information, the vehicle throttle information, the brake application information, the steering wheel information, the vehicle door information, the vehicle compartment information, the vehicle engine information, the in-vehicle communication information, and the real-time position information associated with the vehicle 108. The one or more sensors may include, but are not limited to, an accelerometer, an odometer, a Global Navigation Satellite System (GNSS) sensor (for example, a Global Positioning sensor (GPS)), a temperature sensor, a throttle sensor, a steering sensor, a door sensor, a temperature sensor, an audio sensor, an image sensor, or the like. The plurality of primary signals may further include the login and logout information of the driver 112. The login and logout information of the driver 112 is automatically tracked by the service application (running on the vehicle device 106) based on the use of the vehicle device 106 by the driver 112 to login and logout of an online service platform (hosted by the application server 104) of the ride hailing service provider. The plurality of primary signals may further include the allocation-based call log information that is automatically tracked by the service application (running on the vehicle device 106) based on the use of the vehicle device 106 by the driver 112 to make one or more calls to one or more allocated customers such as the customer 116.

In one embodiment, the vehicle device 106 may be a vehicle head unit. In another embodiment, the vehicle device 106 may be an external communication device, such as a smartphone, a tablet computer, a laptop, or any other portable communication device, that is placed inside the vehicle 108.

The vehicle 108 is a mode of transport that is deployed by the ride hailing service provider to offer on-demand vehicle or ride services to the one or more customers such as the customer 116. The ride hailing service provider may deploy the one or more vehicles (such as the vehicle 108) for offering different types of rides, such as share-rides, non-share rides, rental rides, or the like, to the one or more customers in one or more geographical regions. Examples of the vehicle 108 may include, but are not limited to, an automobile, a bus, a car, and a bike. In one example, the vehicle 108 is a micro-type vehicle such as a compact hatchback vehicle. In another example, the vehicle 108 is a mini-type vehicle such as a regular hatchback vehicle. In another example, the vehicle 108 is a prime-type vehicle such as a prime sedan vehicle, a prime play vehicle, a prime sport utility vehicle (SUV), or a prime executive vehicle. In another example, the vehicle 108 is a lux-type vehicle such as a luxury vehicle.

In an embodiment, the vehicle 108 may include one or more in-vehicle devices or components associated with the one or more in-vehicle systems, such as an infotainment system, a heating, ventilation, and air conditioning (HVAC) system, a navigation system, a power window system, a power door system, a sensor system (including sensors such as the accelerometer, the odometer, the GNSS sensor (for example, a GPS), the temperature sensor, the throttle sensor, the steering sensor, the door sensor, the temperature sensor, the audio sensor, the image sensor), or the like. The one or more in-vehicle systems may be communicatively coupled to the database server 102 or the application server 104 via the communication network 118. The one or more in-vehicle devices or components may also be communicatively coupled to the vehicle device 106, the driver device 110, or the customer device 114 via the in-vehicle communication bus such as the CAN bus of the vehicle 108.

The driver device 110 may include suitable logic, circuitry, interfaces, and/or code, executable by the circuitry, that may be configured to perform one or more operations associated with the performance assessment of the driver 112 of the vehicle 108. The driver device 110 may be a computing device that is utilized by the driver 112 of the vehicle 108 to perform the one or more operations. For example, the driver device 110 may be utilized, by the driver 112, to input or update the driver or vehicle information by using a service application (hosted by the application server 104) running on the driver device 110. The driver device 110 may be further utilized, by the driver 112, to input or update preferences corresponding to one or more languages, multimedia content, in-vehicle temperature, locations, ride types, log-in, log-out, or the like. The driver device 110 may be further utilized, by the driver 112, to view an electronic navigation map (hosted by the application server 104) and to navigate across various locations such as between the pick-up and drop-off locations of the customer 116. The driver device 110 may be further utilized, by the driver 112, to view the allocation information such as current allocation information or future allocation information associated with the vehicle 108. The allocation information may include at least customer information of a customer (such as the customer 116) and ride information of a ride including at least a ride time and the pick-up location associated with the ride initiated by the customer 116.

In an embodiment, the driver device 110 may be further configured to transmit information, such as an availability status, a current booking status, a ride completion status, a ride fare, or the like, associated with the vehicle 108 or the driver 112 to the database server 102 or the application server 104 via the communication network 118. In one example, such information may be automatically detected by the service application running on the driver device 110. In another example, the driver device 110 may be utilized, by the driver 112 of the vehicle 108, to manually update the information after a regular interval of time or after completion of each ride.

In an embodiment, the driver device 110 may be further configured to track real-time position information and communicate this information to the database server 102 or the application server 104 via the communication network 118. In an embodiment, the driver device 110 may be communicatively coupled to at least one of the vehicle device 106 or the one or more sensors installed in the vehicle 108 via the in-vehicle communication network such as the CAN bus or via some other network such as the communication network 118. The driver device 110 may further receive the plurality of primary signals from at least one of the vehicle device 106 or the one or more sensors installed in the vehicle 108. The plurality of primary signals may include at least one of the vehicle dynamics information, the vehicle throttle information, the brake application information, the steering wheel information, the vehicle door information, the vehicle compartment information, the vehicle engine information, the in-vehicle communication information, and the real-time position information associated with the vehicle 108. The plurality of primary signals may further include the login and logout information of the driver 112. The login and logout information of the driver 112 is automatically tracked by the service application (running on the driver device 110) based on the use of the driver device 110 by the driver 112 to login and logout of the online service platform. The plurality of primary signals may further include the allocation-based call log information that is automatically tracked by the service application (running on the driver device 110) based on the use of the driver device 110 by the driver 112 to make one or more calls to one or more allocated customers such as the customer 116.

In an embodiment, the driver device 110 may be further configured to receive one or more notifications associated with one or more trainings or feedback. The one or more notifications may include one or more video tutorials, electronic questionnaires, the driver profile, or the like. The driver profile may include at least one of the driver score, the degree of deviation, the set of positive or negative feedback, and the one or more action items. In some embodiments, the driver profile may also include the plurality of driving parameters and their respective parameter values. The one or more action items may be associated with the set of positive or negative feedback that are executable by the driver 112 within the given time duration, for example, 1 hour, 2 hours, or the like. In case of a failure to complete the one or more action items by the driver 112 in the given time duration, the application server 104 or the service application running on the vehicle device 106 or the driver device 110 may automatically logout the driver 112 from the online service platform (hosted by the application server 104) of the ride hailing service provider. Also, in case of the failure to complete the one or more action items by the driver 112 in the given time duration, the application server 104 or the service application running on the vehicle device 106 or the driver device 110 may immobilize the vehicle 108. In some embodiments, the one or more action items may include one or more instructions that are required to be executed by the driver 112 within the time duration for advancing to a next score level from a current score level in a gamified scoring system. The gamified scoring system (i.e., a gamification technology) may be hosted by the application server 104 in an online manner for stimulating the driver's involvement and personal growth, having leverage on their motivation. The gamified scoring system is implemented to promote the active interest of the one or more drivers, to promote their engagement, and to modify their behaviors.

In one embodiment, the driver device 110 may be a vehicle head unit. In another embodiment, the driver device 110 may be an external communication device, such as a smartphone, a tablet computer, a laptop, or any other portable communication device, that is placed inside the vehicle 108.

The customer device 114 may include suitable logic, circuitry, interfaces, and/or code, executable by the circuitry, that may be configured to perform one or more operations. For example, the customer device 114 may be a computing device that is utilized, by the customer 116, to initiate the one or more operations by using a service application (hosted by the application server 104) running on the customer device 114. The one or more operations may include initiating a booking request for a ride, providing customer feedback corresponding to the performance and behavior of the driver 112, or the like. The customer device 114 may be further utilized, by the customer 116, to view the allocation information corresponding to the allocation of the vehicle 108 by using the service application. The customer device 114 may be further utilized, by the customer 116, to view the driver information corresponding to the allocated vehicle 108 by using the service application. The customer device 114 may be further utilized, by the customer 116, to view the current location information of the allocated vehicle 108 by using the service application. The customer device 114 may be further utilized, by the customer 116, to record comments, ratings, multimedia, or the like by using the service application. The comments, ratings, multimedia, or the like may be recorded based on a ride or travelling experience of the customer 116 with the driver 112 of the vehicle 108. Examples of the customer device 114 may include, but are not limited to, a personal computer, a laptop, a smartphone, a tablet computer, and the like.

The communication network 118 may include suitable logic, circuitry, interfaces, and/or code, executable by the circuitry, that may be configured to transmit queries, signals, messages, data, and requests between various entities, such as the database server 102, the application server 104, the vehicle device 106, the driver device 110, and/or the customer device 114. Examples of the communication network 118 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities in the system environment 100 may be coupled to the communication network 118 in accordance with various wired and wireless communication protocols, such as Transmission Control Protocol and Internet Protocol (TCP/IP), User Datagram Protocol (UDP), Long Term Evolution (LTE) communication protocols, or any combination thereof.

In operation, the application server 104 may be configured to receive the plurality of primary signals from the vehicle device 106 of the vehicle 108. The plurality of signals may be further received from the driver device 110 of the driver 112 associated with the vehicle 108. In some embodiments, the application server 104 may retrieve the plurality of primary signals from the database server 102. In an embodiment, the plurality of primary signals may include at least two or more of the vehicle dynamics information, the vehicle throttle information, the brake application information, the steering wheel information, the vehicle door information, the vehicle compartment information, the vehicle engine information, the in-vehicle communication information, the real-time position information, the allocation-based call log information, and the login and logout information.

In an embodiment, the application server 104 may be further configured to process the plurality of primary signals to generate the plurality of secondary signals. The plurality of secondary signals may include at least two or more of the driving pattern information, the driver's in-vehicle behavior information, the customer's in-vehicle behavior information, the vehicle's performance information, the incident information, the allocation-based responsiveness information, the booking acceptance information, and the customer satisfaction information.

In an embodiment, the driving pattern information may be generated based on at least one of the vehicle dynamics information, the vehicle throttle information, the brake application information, and the vehicle engine information. In an exemplary embodiment, the driving pattern information may indicate a driving pattern category such as a good driving pattern, an average driving pattern, or a bad driving pattern. Each driving pattern category may be associated with a corresponding score. For example, the good driving pattern may be represented by a score “10”, the average driving pattern may be represented by a score “5”, and the bad driving pattern may be represented by a score “2”. In an embodiment, for determining the driving pattern, the application server 104 may process the vehicle dynamics information to obtain a vehicle dynamics score, the vehicle throttle information to obtain a vehicle throttle score, the brake application information to obtain a brake application score, and the vehicle engine information to obtain a vehicle engine score. The application server 104 may further determine a driving pattern score based on at least one of the vehicle dynamics score, the vehicle throttle score, the brake application score, and the vehicle engine score. The application server 104 may further determine the driving pattern (such as the good driving pattern, the average driving pattern, or the bad driving pattern) by comparing the driving pattern score with a first threshold value and a second threshold value. For example, the driving pattern may be determined as the good driving pattern based on a determination that the driving pattern score is greater than the first threshold value. The driving pattern may be determined as the average driving pattern based on a determination that the driving pattern score is between the first threshold value and the second threshold value. The driving pattern may be determined as the bad driving pattern based on a determination that the driving pattern score is less than the second threshold value.

Further, in an embodiment, the driver's in-vehicle behavior information may be generated based on at least one of the brake application information, the steering wheel information, the vehicle door information, and the in-vehicle communication information. In an exemplary embodiment, the driver's in-vehicle behavior information may indicate a behavior category such as a good behavior, an average behavior, or a bad behavior. Each behavior category may be associated with a corresponding score. For example, the good behavior may be represented by a score “10”, the average behavior may be represented by a score “5”, and the bad behavior may be represented by a score “0”. In an embodiment, for determining the driver's in-vehicle behavior, the application server 104 may process the brake application information to obtain a brake application score, the steering wheel information to obtain a steering wheel score, the vehicle door information to obtain a vehicle door score, and the in-vehicle communication information to obtain an in-vehicle communication score. The application server 104 may further determine a driver's behavior score based on at least one of the brake application score, the steering wheel score, the vehicle door score, and the in-vehicle communication score. The application server 104 may further determine the driver's in-vehicle behavior (such as the good behavior, the average behavior, or the bad behavior) by comparing the driver's behavior score with a third threshold value and a fourth threshold value. For example, the driver's in-vehicle behavior may be determined as the good behavior based on a determination that the driver's behavior score is greater than the third threshold value. The driver's in-vehicle behavior may be determined as the average behavior based on a determination that the driver's behavior score is between the third threshold value and the fourth threshold value. The driver's in-vehicle behavior may be determined as the bad behavior based on a determination that the driver's behavior score is less than the fourth threshold value.

Further, in an embodiment, the customer's in-vehicle behavior information may be generated based on at least one of the vehicle door information, the vehicle compartment information, and the in-vehicle communication information. The customer's in-vehicle behavior information may indicate a behavior category such as a good behavior, an average behavior, or a bad behavior. Each behavior category may be associated with a corresponding score. For example, the good behavior may be represented by a score “10”, the average behavior may be represented by a score “5”, and the bad behavior may be represented by a score “0”. In an embodiment, for determining the customer's in-vehicle behavior, the application server 104 may process the vehicle door information to obtain a vehicle door score, the vehicle compartment information to obtain a vehicle compartment score, and the in-vehicle communication information to obtain an in-vehicle communication score. The application server 104 may further determine a customer's behavior score based on at least one of the vehicle door score, the vehicle compartment score, and the in-vehicle communication score. The application server 104 may further determine the customer's in-vehicle behavior (such as the good behavior, the average behavior, or the bad behavior) by comparing the customer's behavior score with a fifth threshold value and a sixth threshold value. For example, the customer's in-vehicle behavior may be determined as the good behavior based on a determination that the customer's behavior score is greater than the fifth threshold value. The customer's in-vehicle behavior may be determined as the average behavior based on a determination that the customer's behavior score is between the fifth threshold value and the sixth threshold value. The customer's in-vehicle behavior may be determined as the bad behavior based on a determination that the customer's behavior score is less than the sixth threshold value.

Further, in an embodiment, the vehicle's performance information may be generated based on at least one of the vehicle dynamics information, the vehicle throttle information, the brake application information, and the vehicle engine information. The vehicle's performance information may indicate a performance category such as a good performance, an average performance, or a bad performance. Each performance category may be associated with a corresponding score. For example, the good performance may be represented by a score “10”, the average performance may be represented by a score “5”, and the bad performance may be represented by a score “3”. In an embodiment, for determining the vehicle's performance, the application server 104 may process the vehicle dynamics information to obtain a vehicle dynamics score, the vehicle throttle information to obtain a vehicle throttle score, the brake application information to obtain a brake application score, and the vehicle engine information to obtain a vehicle engine score. The application server 104 may further determine a vehicle's performance score based on at least one of the vehicle dynamics score, the vehicle throttle score, the brake application score, and the vehicle engine score. The application server 104 may further determine the vehicle's performance (such as the good performance, the average performance, or the bad performance) by comparing the vehicle's performance score with a seventh threshold value and an eighth threshold value. For example, the vehicle's performance may be determined as the good performance based on a determination that the vehicle's performance score is greater than the seventh threshold value. The vehicle's performance may be determined as the average performance based on a determination that the vehicle's performance score is between the seventh threshold value and the eighth threshold value. The vehicle's performance may be determined as the bad performance based on a determination that the vehicle's performance score is less than the eighth threshold value.

Further, in an embodiment, the incident information corresponding to one or more incidents (such as accidents, arguments, fights, or the like) may be generated based on at least one of the vehicle dynamics information, the brake application information, the steering wheel information, the vehicle door information, the vehicle engine information, the in-vehicle communication information, and the real-time position information. The incident information may indicate a count of incidents incurred by the driver 112 during the one or more rides associated with a fixed time interval such as 1 hour, 5 hours, 10 hours, 15 hours, 24 hours, or the like. For example, when the count of incidents during the one or more rides is equal to a first value (such as “10”), a severity of the incidents may be represented by a score “10” (=100/10). In another example, when the count of incidents during the one or more rides is equal to a second value (such as “5”), a severity of the incidents may be represented by a score “20” (=100/5). In another example, when the count of incidents during the one or more rides is equal to a third value (such as “1”), a severity of the incidents may be represented by a score “100” (=100/1). In another example, when the count of incidents during the one or more rides is equal to a fourth value (such as “0”), a severity of the incidents may be represented by a fixed score “500”. In another example, when the count of incidents during the one or more rides is equal to a fifth value (such as “20”), a severity of the incidents may be represented by a fixed score “5” (=100/20).

Further, in an embodiment, the allocation-based responsiveness information may be generated based on at least one of the vehicle compartment information, the real-time position information, the login and logout information, and the allocation-based call log information. The allocation-based responsiveness information may indicate a response category such as a quick response, a delayed response, or a no response. Each response category may be associated with a corresponding score. For example, the quick response may be represented by a score “10”, the delayed response may be represented by a score “5”, and the no response may be represented by a score “0”. In an embodiment, for determining the allocation-based responsiveness, the application server 104 may process the vehicle compartment information to obtain a vehicle compartment score, the real-time position information to obtain a position score, the login and logout information to obtain a log-in-out score, and the allocation-based call log information to obtain an allocation-based call log score. The application server 104 may further determine a responsiveness score based on at least one of the vehicle compartment score, the position score, the log-in-out score, and the allocation-based call log score. The application server 104 may further determine the allocation-based responsiveness (such as the quick response, the delayed response, or the no response) by comparing the responsiveness score with a ninth threshold value and a tenth threshold value. For example, the allocation-based responsiveness may be determined as the the quick response based on a determination that the responsiveness score is greater than the ninth threshold value. The allocation-based responsiveness may be determined as the delayed response based on a determination that the responsiveness score is between the ninth threshold value and the tenth threshold value. The allocation-based responsiveness may be determined as the no response based on a determination that the responsiveness score is less than the tenth threshold value. Similarly, the booking acceptance information may be generated based on at least one of the allocation information, the allocation-based call log information, and the real-time position information. For determining the booking acceptance rate, the application server 104 may process at least one of the allocation information, the allocation-based call log information, and the real-time position information to determine an acceptance score. The acceptance score may indicate an intent of the driver 112 for providing ride services to the customer 116 and may be measured in terms of a rate at which the booking request is accepted by the driver 112, a call is made to the customer 116 by the driver 112 based on the allocation, and the vehicle 108 is driven towards the pick-up location of the customer 116 by the driver 112.

In an embodiment, the customer satisfaction information may be generated based on at least one of the vehicle compartment information, the customer feedback information, and the in-vehicle communication information. The customer satisfaction information may indicate a satisfactory category such as a high satisfaction, an average satisfaction, or a low satisfaction. Each satisfaction category may be associated with a corresponding score. For example, the high satisfaction may be represented by a score “10”, the average satisfaction may be represented by a score “5”, and the low satisfaction may be represented by a score “0”. In an embodiment, for determining the customer satisfaction, the application server 104 may process the vehicle compartment information to obtain a vehicle compartment score, the customer feedback information to obtain a feedback score, and the in-vehicle communication information to obtain an in-vehicle communication score. The application server 104 may further determine a customer satisfaction score based on at least one of the vehicle compartment score, the feedback score, and the in-vehicle communication score. The application server 104 may further determine the customer satisfaction (such as the high satisfaction, the average satisfaction, or the low satisfaction) by comparing the customer satisfaction score with an eleventh threshold value and a twelfth threshold value. For example, the customer satisfaction may be determined as the high satisfaction based on a determination that the customer satisfaction score is greater than the eleventh threshold value. The customer satisfaction may be determined as the average satisfaction based on a determination that the customer satisfaction score is between the eleventh threshold value and the twelfth threshold value. The customer satisfaction may be determined as the low satisfaction based on a determination that the customer satisfaction score is less than the twelfth threshold value.

In some embodiments, the application server 104 may be further configured to receive the customer feedback corresponding to the performance and behavior of the driver 112 from the customer device 114 of the customer 116. The customer feedback may include at least one of one or more comments, a rating, or a multimedia recording that is indicative of the performance and behavior of the driver 112. The customer feedback may be received for an ongoing ride or a completed ride associated with the vehicle 108 and the driver 112. The application server 104 may be further configured to normalize the customer feedback based on the historical customer feedback associated with the customer 116. The customer feedback may be normalized to obtain a normalized feedback signal that indicates at least a degree of severity of the customer feedback. For example, when the historical customer feedback is generally below par (such as a rating of 2 or less out of 5) for most of the rides availed by the customer 116 in the past and the historical customer feedback does not include any specific comments for disliking the rides, it may not be reliable to actually trust the customer feedback received for the driver 112 from the customer device 114 of the customer 116. In such a case, the application server 104 may normalize the customer feedback to an average rating (such as a rating of 3 out of 5). Similarly, when the historical customer feedback is generally above par (such as a rating of 5 out of 5) for most of the rides availed by the customer 116 in the past and the historical customer feedback does not include any specific comments for liking the rides, it may not be reliable to actually trust the customer feedback received for the driver 112 from the customer device 114 of the customer 116. In such a case, the application server 104 may normalize the customer feedback to an average rating (such as a rating of 3). The application server 104 may further generate or update one or more of the plurality of secondary signals based on the normalized feedback signal.

In an embodiment, the application server 104 may be further configured to generate the driver profile of the driver 112 based on at least the plurality of secondary signals. The driver profile may include at least a plurality of driving parameters and their respective parameter values. The plurality of driving parameters and their respective parameter values may be determined based on at least the plurality of secondary signals. For example, the plurality of driving parameters may include at least two or more of a driver's driving parameter, a driver's in-vehicle behavior parameter, a driver's responsiveness parameter, a driver's performance parameter, a driver's incident-based parameter, or the like. A parameter value for the driver's driving parameter may be determined based on at least one of the driving pattern information (such as the driving pattern score or the score associated with the driving pattern category), the vehicle's performance information (such as the vehicle's performance score or the score associated with the performance category), and the incident information (such as the severity of the incidents). Similarly, a parameter value for the driver's in-vehicle behavior parameter may be determined based on at least one of the driver's in-vehicle behavior information (such as the driver's behavior score or the score associated with the driver's behavior category) and the customer's in-vehicle behavior information (such as the customer's behavior score or the score associated with the customer's behavior category). Similarly, a parameter value for the driver's responsiveness parameter may be determined based on at least one of the allocation-based responsiveness information (such as the responsiveness score or the score associated with the response category) and the booking acceptance information (such as the acceptance score or the score associated with the acceptance category). Similarly, a parameter value for the driver's performance parameter may be determined based on at least one of the driving pattern information (such as the driving pattern score or the score associated with the driving pattern category), the driver's in-vehicle behavior information (such as the driver's behavior score or the score associated with the driver's behavior category), the customer's in-vehicle behavior information (such as the customer's behavior score or the score associated with the customer's behavior category), the vehicle's performance information (such as the vehicle's performance score or the score associated with the performance category), the incident information (such as the severity of the incidents), the allocation-based responsiveness information (such as the responsiveness score or the score associated with the response category), the booking acceptance information (such as the acceptance score or the score associated with the acceptance category), and the customer satisfaction information (such as the customer satisfaction score or the score associated with the satisfaction category). Similarly, a parameter value for the driver's incident-based parameter may be determined based on at least one of the driving pattern information (such as the driving pattern score or the score associated with the driving pattern category) and the incident information (such as the severity of the incidents).

In an embodiment, the application server 104 may be further configured to determine the driver score corresponding to the performance and behavior of the driver 112. The driver score may be determined based on the parameter values of the plurality of driving parameters. The application server 104 may be further configured to determine the degree of deviation. The degree of deviation may be determined by comparing the driver score with the baseline threshold value. The baseline threshold value may be determined based on at least one of the type of the vehicle 108, the geographical region in which the driver 112 is driving the vehicle 108, the working hours of the driver 112, or the historical performance and rating of the driver 112. The application server 104 may be further configured to detect the positive or negative deviation in the performance and behavior of the driver 112 based on degree of deviation. For example, based on a positive difference between the driver score and the baseline threshold value (i.e., the driver score is greater than the baseline threshold value), the application server 104 may detect the deviation in the performance and behavior of the driver 112 as the positive deviation. Further, based on a negative difference between the driver score and the baseline threshold value (i.e., the driver score is less than the baseline threshold value), the application server 104 may detect the deviation in the performance and behavior of the driver 112 as the negative deviation.

In an embodiment, the application server 104 may be further configured to communicate the driver profile to the driver 112. The driver profile may include at least the driver score and the degree of deviation. The driver profile may further include the set of positive or negative feedback and the one or more action items. The set of positive or negative feedback may be generated in real-time based on the positive or negative deviation, respectively. The one or more action items may be associated with the set of positive or negative feedback. In an embodiment, the set of positive feedback may be presented to the driver 112 by using the gamified scoring system including a plurality of score levels. In an embodiment, the one or more action items associated with the set of positive feedback may include one or more instructions that are executable by the driver 112 within the time duration for advancing to the next score level (i.e., future driving score) from the current score level (i.e., current driving score) in the gamified scoring system. In an embodiment, each score level may be associated with an offer along with an allotment preference for one or more future rides. In an embodiment, the one or more action items associated with the set of negative feedback may include at least one of one or more warning messages or cool-off periods for future allotments. The one or more action items associated with the set of negative feedback may further include a suspension for retraining. The retraining may include presentation of the one or more video tutorials on the driver device 110, followed by the electronic questionnaires. The electronic questionnaires may be responded by the driver 112 via a touch-based input, a key-based input, or a voice-based input. In an embodiment, the set of positive or negative feedback may be communicated to the driver 112 via the service application running on the vehicle device 106 or the driver device 110. Further, the set of positive or negative feedback may be communicated to the driver 112 via an interactive voice response (IVR) call or a short message service (SMS). The one or more action items associated with the set of negative feedback may be required to be executed or completed by the driver 112 within the given time duration. In case of the failure to complete the one or more action items (for example, action item(s) associated with the set of negative feedback) by the driver 112 in the given time duration, the application server 104 or the service application (running on the vehicle device 106 or the driver device 110) may be configured to automatically logout the driver 112 from the online service platform of the ride hailing service provider. In such a case, the application server 104 may not communicate any new booking requests for new rides to the driver 112 of the vehicle 108. Also, in case of the failure to complete the one or more action items (for example, action item(s) associated with the set of negative feedback) by the driver 112 in the given time duration, the application server 104 or the service application (running on the vehicle device 106 or the driver device 110) may be configured to immobilize the vehicle 108. In such a case, the vehicle 108 may not be used by the driver 112 for further travelling. Further, the application server 104 may not communicate any new booking requests for new rides to the driver 112 of the vehicle 108. Further, after immobilizing the vehicle 108, the application server 104 or the service application (running on the vehicle device 106 or the driver device 110) may be configured to generate and communicate a notification message to the driver 112. The notification message may include the one or more pending action items associated with the set of negative feedback. The notification message may further include a request to complete the one or more pending action items within an extended time duration. Post the completion and submission of the one or more pending action items within an extended time duration by the driver 112, the application server 104 or the service application (running on the vehicle device 106 or the driver device 110) may be configured to lift or release the immobilization of the vehicle 108 and the vehicle 108 may be used by the driver 112 for continued travelling. Also, the application server 104 may further start communicating any new booking requests for new rides to the driver 112 of the vehicle 108 based on the driver's current location.

FIG. 2 is a block diagram that illustrates the application server 104, in accordance with an exemplary embodiment of the disclosure. The application server 104 includes circuitry such as a processor 202, a memory 204, a vehicle detection engine 206, a data mining engine 208, a score calculator engine 210, a notification engine 212, an allocation engine 214, and a transceiver 216. The processor 202, the memory 204, the vehicle detection engine 206, the data mining engine 208, the score calculator engine 210, the notification engine 212, the allocation engine 214, and the transceiver 216 may communicate with each other via a communication bus (not shown).

The processor 202 may include suitable logic, circuitry, interfaces, and/or code, executable by the circuitry, that may be configured to perform one or more operations associated with the performance assessment of the one or more drivers. Examples of the processor 202 may include, but are not limited to, an application-specific integrated circuit (ASIC) processor, a reduced instruction set computing (RISC) processor, a complex instruction set computing (CISC) processor, and a field-programmable gate array (FPGA). The processor 202 may also correspond to a central processing units (CPU), a graphics processing unit (GPUs), a network processing units (NPU), a digital signal processors (DSP), or the like. In some embodiments, the processor 202 may be realized by using a machine-learning model that implements any suitable machine-learning techniques, statistical techniques, or probabilistic techniques for performing the one or more operations. It will be apparent to a person skilled in the art that the processor 202 may be compatible with multiple operating systems.

In an embodiment, the processor 202 may be configured to process the plurality of primary signals to generate the plurality of secondary signals. The processor 202 may be further configured to generate the driver profile of the one or more drivers such as the driver 112 of the vehicle 108. The processor 202 may be further configured to determine the degree of deviation to detect the positive or negative deviation in the performance and behavior of the driver 112. The processor 202 may be further configured to communicate the driver profile to the driver 112 of the vehicle 108. The driver profile may include the driver score, the degree of deviation, the set of positive or negative feedback, and the one or more action items. The processor 202 may be further configured to normalize the customer feedback based on the historical customer feedback associated with the customer 116 and obtain the normalized feedback signal that indicates at least the degree of severity of the customer feedback. The plurality of secondary signals may further be generated or updated based on the normalized feedback signal. The processor 202 may be further configured to automatically logout the driver 112 from the online service platform of the ride hailing service provider in case of the failure to complete the one or more action items by the driver 112 in the given time duration. The processor 202 may be further configured to immobilize the vehicle 108 in case of the failure to complete the one or more action items by the driver 112 in the given time duration. The processor 202 may be further configured to lift or release the immobilization of the vehicle 108 after the completion and submission of the one or more pending action items within the extended time duration by the driver 112.

In an embodiment, the processor 202 may be configured to operate as a master processing unit, and each of the memory 204, the vehicle detection engine 206, the data mining engine 208, the score calculator engine 210, the notification engine 212, the allocation engine 214, and the transceiver 216 may be configured to operate as a slave processing unit. In such a scenario, the processor 202 may be configured to generate and communicate one or more instructions or control commands to the memory 204, the vehicle detection engine 206, the data mining engine 208, the score calculator engine 210, the notification engine 212, the allocation engine 214, and the transceiver 216 to perform their corresponding operations either independently or in conjunction with each other.

The memory 204 may include suitable logic, circuitry, interfaces, and/or code, executable by the circuitry, that may be configured to store one or more instructions that are executed by the processor 202, the vehicle detection engine 206, the data mining engine 208, the score calculator engine 210, the notification engine 212, the allocation engine 214, and the transceiver 216 to perform their operations. The memory 204 may be configured to temporarily store and manage the historical feedback associated with the customers (such as the customer 116), drivers (such as the driver 112), and vehicles (such as the vehicle 108). The memory 204 may be further configured to temporarily store and manage the plurality of primary signals such as the vehicle dynamics information, the vehicle throttle information, the brake application information, the steering wheel information, the vehicle door information, the vehicle engine information, the in-vehicle communication information, the real-time position information, the allocation-based call log information, the login and logout information, or the like. The memory 204 may be further configured to temporarily store and manage the historical performance and rating of the driver 112 and the historical performance and rating of the customer 116. The memory 204 may be further configured to temporarily store and manage the type of the vehicle 108, the geographical region in which the driver 112 is driving the vehicle 108, the working hours of the driver 112, the historical accidental data associated with the driver 112, or the like. The memory 204 may be further configured to temporarily store and manage the plurality of secondary signals such as the driving pattern information, the driver's in-vehicle behavior information, the customer's in-vehicle behavior information, the vehicle's performance information, the incident information, the allocation-based responsiveness information, and the customer satisfaction information. The memory 204 may be further configured to temporarily store and manage the driver profile, the driver score, the positive or negative deviation, the set of positive or negative feedback, and the one or more action items. Examples of the memory 204 may include, but are not limited to, a random-access memory (RAM), a read-only memory (ROM), a programmable ROM (PROM), and an erasable PROM (EPROM).

The vehicle detection engine 206 may include suitable logic, circuitry, interfaces, and/or code, executable by the circuitry, that may be configured to perform one or more operations associated with detection of the one or more vehicles in the geographical region. For example, the vehicle detection engine 206 may be configured to track and manage the real-time position information of each of the one or more vehicles (such as the vehicle 108) based on location pings received from one or more GNSS sensors (such as a GPS) of at least one of the vehicle device 106, the vehicle 108, or the driver device 110. Further, the vehicle detection engine 206 may be configured to process the real-time position information to detect the current location of each of the one or more vehicles in the geographical region. The vehicle detection engine 206 may be implemented by one or more processors, such as, but are not limited to, an ASIC processor, a RISC processor, a CISC processor, and an FPGA.

The data mining engine 208 may include suitable logic, circuitry, interfaces, and/or code, executable by the circuitry, that may be configured to perform one or more operations associated with data mining. For example, the data mining engine 208 may be configured to receive the plurality of primary signals from at least one of the vehicle device 106 of the vehicle 108 or the driver device 110 of the driver 112 associated with the vehicle 108. The data mining engine 208 may be further configured to receive the customer feedback corresponding to the performance and behavior of the driver 112 from the customer device 114 of the customer 116. The data mining engine 208 may be implemented by one or more processors, such as, but are not limited to, an ASIC processor, a RISC processor, a CISC processor, and an FPGA.

The score calculator engine 210 may include suitable logic, circuitry, interfaces, and/or code, executable by the circuitry, that may be configured to perform one or more operations associated with calculation of one or more scores that are required for assessing the performance of the one or more drivers. For example, the score calculator engine 210 may be configured to determine the vehicle dynamics score, the vehicle throttle score, the brake application score, the steering wheel score, the vehicle door score, the vehicle compartment score, the vehicle engine score, the in-vehicle communication score, the position score, the log-in-out score, and the allocation-based call log score. The score calculator engine 210 may be further configured to determine the driving pattern score, the driver's behavior score, the customer's behavior score, the vehicle's performance score, the score associated with the severity of the incidents, the responsiveness score, the customer satisfaction score, or the like. The score calculator engine 210 may be further configured to determine the parameter value corresponding to each of the plurality of driving parameters such as the driver's driving parameter, the driver's in-vehicle behavior parameter, the driver's responsiveness parameter, the driver's performance parameter, the driver's incident-based parameter, or the like. The score calculator engine 210 may be further configured to determine the driver score corresponding to the performance and behavior of the driver 112 based on the parameter values of the plurality of driving parameters. The score calculator engine 210 may be further configured to determine the baseline threshold value based on at least one of the type of the vehicle 112, the geographical region in which the driver 112 is driving the vehicle 108, the working hours of the driver 112, or the historical performance and rating of the driver 112. The score calculator engine 210 may be implemented by one or more processors, such as, but are not limited to, an ASIC processor, a RISC processor, a CISC processor, and an FPGA.

The notification engine 212 may include suitable logic, circuitry, interfaces, and/or code, executable by the circuitry, that may be configured to perform one or more operations associated with generation and communication of one or more notifications to the one or more drivers or customers. For example, the notification engine 212 may be configured to generate and communicate one or more notifications associated with one or more new booking requests to the one or more drivers. The notification engine 212 may be further configured to generate and communicate one or more notifications associated with one or more allocations to the one or more drivers and customers. The notification engine 212 may be further configured to generate and communicate one or more notifications associated with the set of positive or negative feedback to the one or more drivers. The notification engine 212 may be further configured to generate and communicate one or more notifications associated with the one or more action items to the one or more drivers. In an embodiment, the notification engine 212 may be further configured to generate one or more notification interfaces corresponding to the one or more notifications and render the one or more notification interfaces on the vehicle device 106, the driver device 110, or the customer device 114. The notification engine 212 may be implemented by one or more processors, such as, but are not limited to, an ASIC processor, a RISC processor, a CISC processor, and an FPGA.

The allocation engine 214 may include suitable logic, circuitry, interfaces, and/or code, executable by the circuitry, that may be configured to perform one or more operations associated with the one or more allocations. For example, the allocation engine 214 may be configured to allocate the one or more vehicles (such as the vehicle 108) to the one or more customers (such as the customer 116) based on the one or more booking requests accepted by the one or more drivers (such as the driver 112). The allocation engine 214 may be implemented by one or more processors, such as, but are not limited to, an ASIC processor, a RISC processor, a CISC processor, and an FPGA.

The transceiver 216 may include suitable logic, circuitry, interfaces, and/or code, executable by the circuitry, that may be configured to transmit (or receive) data to (or from) various servers or devices, such as the database server 102, the vehicle device 106, the driver device 110, or the customer device 114 via the communication network 118. Examples of the transceiver 216 may include, but are not limited to, an antenna, a radio frequency transceiver, a wireless transceiver, and a Bluetooth transceiver. The transceiver 216 may be configured to communicate with the database server 102, the vehicle device 106, the driver device 110, or the customer device 114 using various wired and wireless communication protocols, such as TCP/IP, UDP, LTE communication protocols, or any combination thereof.

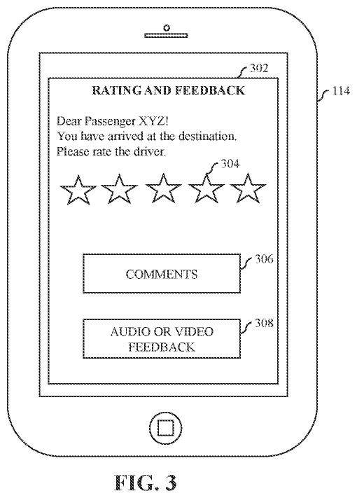

FIG. 3 is a block diagram that illustrates a first notification interface 302 rendered on the customer device 114, in accordance with an exemplary embodiment of the disclosure. In an embodiment, the application server 104 may be configured to generate the first notification interface 302 during the ride or after the completion of the ride and render the first notification interface 302 for display on the customer device 114 by using the service application running on the customer device 114. The first notification interface 302 may be generated and rendered on the customer device 114 for obtaining the customer's feedback based on the ride experience (ongoing or completed) with the driver 112 in the vehicle 108. The first notification interface 302 may include one or more options such as a rating option 304, a comment option 306, and an audio or video feedback option 308. The rating option 304 may be used by the customer 116 to input a performance rating of the driver 112 of the vehicle 108. The comment option 306 may be used by the customer 116 to input the one or more comments (in text format) for the driver 112 of the vehicle 108 or the ride hailing service provider associated with the vehicle 108 or the driver 112. The audio or video feedback option 308 may be used by the customer 116 to record a multimedia content (for example, an audio or video content) associated with the one or more comments. The audio or video feedback option 308 may be further used by the customer 116 to capture one or more images (for example, still or moving images) of the vehicle compartment of the vehicle 108.

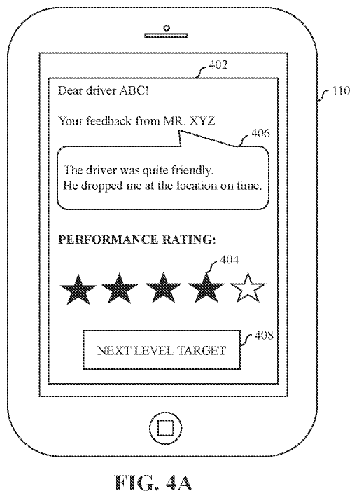

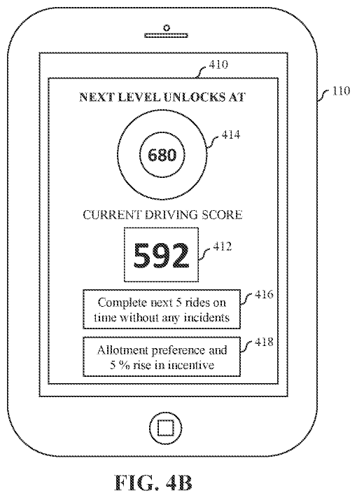

FIG. 4A is a block diagram that illustrates a second notification interface 402 rendered on the driver device 110, in accordance with an exemplary embodiment of the disclosure. In an embodiment, the application server 104 may be configured to generate the second notification interface 402 after the completion of the ride and render the second notification interface 402 for display on the driver device 110 by using the service application running on the driver device 110. The second notification interface 402 may be generated and rendered on the driver device 110 for presenting the customer's feedback to the driver 112. The customer's feedback may include at least the performance rating (as shown by 404) and the one or more comments (as shown by 406) received from the customer device 114 of the customer 116 who took the ride in the vehicle 108 of the driver 112. The second notification interface 402 may include a next level target option 408 that is selectable by the driver 112 to view one or more future targets in terms of one or more targeted scores along with the related instructions and offers associated with each targeted score.

FIG. 4B is a block diagram that illustrates a third notification interface 408 rendered on the driver device 110, in accordance with an exemplary embodiment of the disclosure. In an embodiment, the application server 104 may be configured to generate the third notification interface 410 after the completion of the ride and render the third notification interface 410 for display on the driver device 110 by using the service application running on the driver device 110. The third notification interface 410 may be generated and rendered on the driver device 110 based on the selection of the next level target option 408 presented on the second notification interface 402. The third notification interface 410 may include a current driving score (“592”, as shown by 412) of the driver 112. The current driving score may correspond to the performance and behavior of the driver 112 and may be determined based on the parameter values associated with the plurality of driving parameters. The plurality of driving parameters may be associated with the plurality of secondary signals. The plurality of secondary signals may be generated based on the plurality of primary signals associated with the one or more rides completed by the driver 112. The third notification interface 410 may further include a next target score (“680”, as shown by 414) associated with a target set for the driver 112. The third notification interface 410 may further include an instruction section 416 for communicating the one or more instructions to the driver 112 for reaching the next target score. For example, the instruction section 416 instructs the driver 112 to complete the next 5 rides on time without incurring any incidents (such as accidents or arguments). The third notification interface 410 may further include an offer section 418 for communicating one or more offers associated with the next target score to the driver 112. The one or more offers may be availed by the driver 112 based on reaching of the next target score by complying the one or more instructions associated with the next target score. For example, the one or more offers may include providing allotment preferences for the one or more future rides and providing “5 percent” rise in incentive.

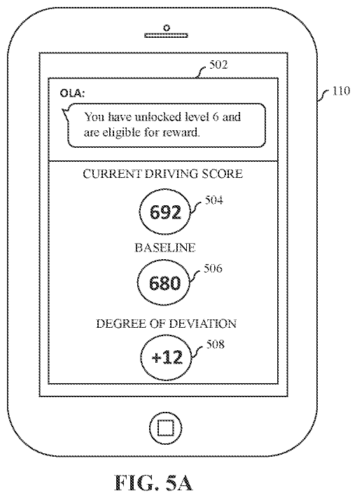

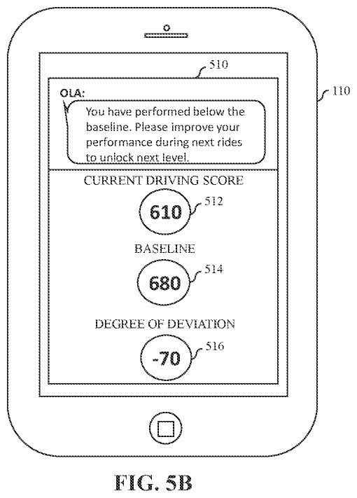

FIG. 5A is a block diagram that illustrates a fourth notification interface 502 rendered on the driver device 110, in accordance with an exemplary embodiment of the disclosure. In an embodiment, the application server 104 may be configured to generate the fourth notification interface 502 after the completion of the set target by driver 112 and render the fourth notification interface 502 for display on the driver device 110 by using the service application running on the driver device 110. In an exemplary embodiment, the fourth notification interface 502 may be generated and rendered on the driver device 110 based on the determination that the degree of deviation indicates the positive deviation in the performance and behavior of the driver 112. For example, after the completion of the set target by the driver 112, the application server 104 may determine the current driving score (“692”, as shown by 504). Thereafter, the application server 104 may determine the degree of deviation by comparing the current driving score with the baseline threshold value (“680”, as shown by 506). Since the current driving score (“692”) is greater than the baseline threshold value (“680”), the application server 104 may determine the degree of deviation as the positive deviation (“+12”, as shown by 508) in the performance and behavior of the driver 112. Based on the detected positive deviation, the application server 104 may present the set of positive feedback to the driver 112. The set of positive feedback (such as the one or more offers and the one or more instructions for advancing to the next score level from the current score level) may be presented by using the gamified scoring system including the plurality of score levels. Each score level may be associated with the one or more offers along with the allotment preference for the one or more future rides. Further, the application server 104 may present the one or more action items associated with the set of positive feedback. The one or more action items may include the one or more instructions for advancing to the next score level from the current score level in the gamified scoring system. The application server 104 may be further configured to generate a ranking table that includes a rank of the driver 112 in comparison to other drivers who are participants of the gamified scoring system. In one example, the ranking table (including ranking of all the participating drivers) may be generated based on the current driving score of each participant driver i.e., higher the driving score, higher the rank in the gamified scoring system. In another example, the ranking table (including ranking of all the participating drivers) may be generated based on the degree of deviation (i.e., the positive deviation) of each participant driver i.e., higher the degree of deviation, higher the rank in the gamified scoring system. The application server 104 may use the ranking of all the participating drivers of the gamified scoring system to allocate and distribute the one or more offers. For example, a high ranked driver may get more offers (for example, a higher percentage of incentive, a higher number of allotment preferences, or the like) than a low ranked driver (for example, a lower percentage of incentive, a lower number of allotment preferences, or the like).

FIG. 5B is a block diagram that illustrates a fifth notification interface 510 rendered on the driver device 110, in accordance with an exemplary embodiment of the disclosure. In an embodiment, the application server 104 may be configured to generate the fifth notification interface 510 after the completion of the set target by driver 112 and render the fifth notification interface 510 for display on the driver device 110 by using the service application running on the driver device 110. In an exemplary embodiment, the fifth notification interface 510 may be generated and rendered on the driver device 110 based on the determination that the degree of deviation indicates the negative deviation in the performance and behavior of the driver 112. For example, after the completion of the set target by the driver 112, the application server 104 may determine the current driving score (“610”, as shown by 512). Thereafter, the application server 104 may determine the degree of deviation by comparing the current driving score with the baseline threshold value (“680”, as shown by 514). Since the current driving score (“610”) is less than the baseline threshold value (“680”), the application server 104 may determine the degree of deviation as the negative deviation (“−70”, as shown by 516) in the performance and behavior of the driver 112. Based on the detected negative deviation, the application server 104 may present the set of negative feedback to the driver 112. The set of negative feedback may include the one or more action items such as the one or more warning messages or cool-off periods for the future allotments. The one or more action items may further include the suspension for retraining. The retraining may include presentation of the one or more video tutorials on the driver device 110, followed by the electronic questionnaires. The one or more action items associated with the set of negative feedback may be required to be executed or completed by the driver 112 within the given time duration.

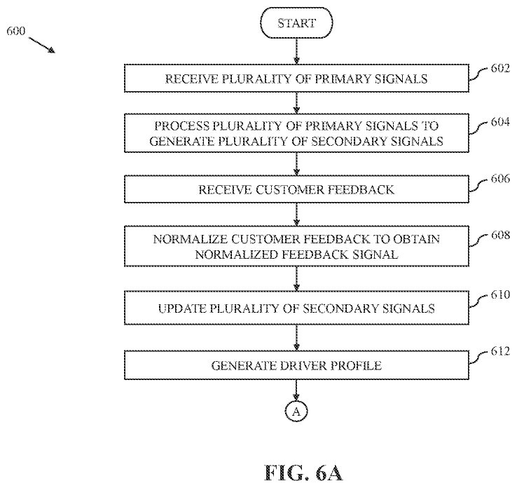

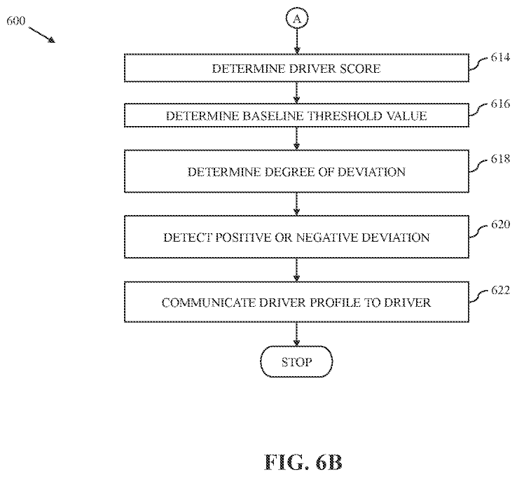

FIGS. 6A and 6B, collectively, is a diagram that illustrates a flow chart 600 of a method for assessing performance of the driver 112 of the vehicle 108, in accordance with an exemplary embodiment of the disclosure.

At 602, the plurality of primary signals is received. In an embodiment, the application server 104 may be configured to receive the plurality of primary signals from the vehicle device 106 of the vehicle 108 and the driver device 110 of the driver 112 associated with the vehicle 108. In some embodiments, the application server 104 may retrieve the plurality of primary signals from the database server 102. In an embodiment, the plurality of primary signals may include at least two or more of the vehicle dynamics information, the vehicle throttle information, the brake application information, the steering wheel information, the vehicle door information, the vehicle compartment information, the vehicle engine information, the in-vehicle communication information, the real-time position information, the allocation-based call log information, and the login and logout information.

At 604, the plurality of primary signals is processed to generate the plurality of secondary signals. In an embodiment, the application server 104 may be further configured to process the plurality of primary signals to generate the plurality of secondary signals. The plurality of secondary signals may include at least two or more of the driving pattern information, the driver's in-vehicle behavior information, the customer's in-vehicle behavior information, the vehicle's performance information, the incident information, the allocation-based responsiveness information, the booking acceptance information, and the customer satisfaction information.

At 606, the customer feedback is received. In an embodiment, the application server 104 may be further configured to receive the customer feedback corresponding to the performance and behavior of the driver 112 from the customer device 114 of the customer 116. The customer feedback may include at least one of the one or more comments, the rating, or the multimedia recording that is indicative of the performance and behavior of the driver 112. The customer feedback may be received for an ongoing ride or a completed ride associated with the vehicle 108 and the driver 112.

At 608, the customer feedback is normalized to obtain the normalized feedback signal. In an embodiment, the application server 104 may be further configured to normalize the customer feedback based on the historical customer feedback associated with the customer 116. The customer feedback may be normalized to obtain the normalized feedback signal that indicates at least the degree of severity of the customer feedback.

At 610, the plurality of secondary signals is updated. In an embodiment, the application server 104 may be further configured to update one or more of the plurality of secondary signals based on the normalized feedback signal.

At 612, the driver profile is generated. In an embodiment, the application server 104 may be further configured to generate the driver profile of the driver 112 based on at least the plurality of secondary signals. The driver profile may include at least the plurality of driving parameters and their respective parameter values. The plurality of driving parameters may include at least two or more of the driver's driving parameter, the driver's in-vehicle behavior parameter, the driver's responsiveness parameter, the driver's performance parameter, the driver's incident-based parameter, or the like.

At 614, the driver score is determined. In an embodiment, the application server 104 may be further configured to determine the driver score corresponding to the performance and behavior of the driver 112. The driver score may be determined based on the parameter values of the plurality of driving parameters.

At 616, the baseline threshold value is determined. In an embodiment, the application server 104 may be further configured to determine the baseline threshold value. The baseline threshold value may be determined based on at least one of the type of the vehicle 108, the geographical region in which the driver 112 is driving the vehicle 108, the working hours of the driver 112, or the historical performance and rating of the driver 112.

At 618, the degree of deviation is determined. In an embodiment, the application server 104 may be further configured to determine the degree of deviation. The degree of deviation may be determined by comparing the driver score with the baseline threshold value.

At 620, the positive or negative deviation is detected. In an embodiment, the application server 104 may be further configured to detect the positive or negative deviation in the performance and behavior of the driver 112 based on the degree of deviation.

At 622, the driver profile is communicated to the driver 112. In an embodiment, the application server 104 may be further configured communicate the driver profile to the driver 112. The driver profile may include at least the driver score and the degree of deviation. The driver profile may further include the set of positive or negative feedback and the one or more action items. The set of positive or negative feedback may be generated in real-time based on the positive or negative deviation, respectively. The one or more action items may be associated with the set of positive or negative feedback. In an embodiment, the set of positive feedback may be presented to the driver 112 by using the gamified scoring system. In an embodiment, the one or more action items associated with the set of positive feedback may include the one or more instructions that are executable by the driver 112 within the given time duration for advancing to the next score level from the current score level in the gamified scoring system. In an embodiment, each score level may be associated with the one or more offers along with the allotment preference for the one or more future rides. In an embodiment, the one or more action items associated with the set of negative feedback may include at least one of the one or more warning messages or the cool-off periods for the one or more future allotments. The one or more action items associated with the set of negative feedback may further include the suspension for retraining. The retraining may include presentation of the one or more video tutorials on the driver device 110, followed by the electronic questionnaires. The electronic questionnaires may be responded by the driver 112 via the touch-based input, the key-based input, or the voice-based input. In an embodiment, the set of positive or negative feedback may be communicated to the driver 112 via the service application running on the vehicle device 106 or the driver device 110. Further, the set of positive or negative feedback may be communicated to the driver 112 via the IVR call or the SMS. The one or more action items associated with the set of negative feedback may be required to be executed or completed by the driver 112 within the given time duration.

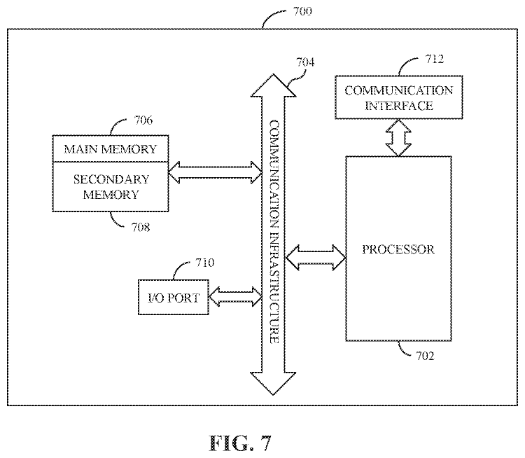

FIG. 7 is a block diagram that illustrates a system architecture of a computer system 700 for assessing the performance of the driver 112, in accordance with an exemplary embodiment of the disclosure. An embodiment of the disclosure, or portions thereof, may be implemented as computer readable code on the computer system 700. In one example, the database server 102 or the application server 104 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIGS. 6A and 6B.

The computer system 700 may include a processor 702 that may be a special purpose or a general-purpose processing device. The processor 702 may be a single processor, multiple processors, or combinations thereof. The processor 702 may have one or more processor “cores.” Further, the processor 702 may be coupled to a communication infrastructure 704, such as a bus, a bridge, a message queue, multi-core message-passing scheme, the communication network 118, or the like. The computer system 700 may further include a main memory 706 and a secondary memory 708. Examples of the main memory 706 may include RAM, ROM, and the like. The secondary memory 708 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The computer system 700 may further include an input/output (I/O) port 710 and a communication interface 712. The I/O port 710 may include various input and output devices that are configured to communicate with the processor 702. Examples of the input devices may include a keyboard, a mouse, a joystick, a touchscreen, a microphone, and the like. Examples of the output devices may include a display screen, a speaker, headphones, and the like. The communication interface 712 may be configured to allow data to be transferred between the computer system 700 and various devices that are communicatively coupled to the computer system 700. Examples of the communication interface 712 may include a modem, a network interface, i.e., an Ethernet card, a communication port, and the like. Data transferred via the communication interface 712 may be signals, such as electronic, electromagnetic, optical, or other signals as will be apparent to a person skilled in the art. The signals may travel via a communications channel, such as the communication network 118, which may be configured to transmit the signals to the various devices that are communicatively coupled to the computer system 700. Examples of the communication channel may include a wired, wireless, and/or optical medium such as cable, fiber optics, a phone line, a cellular phone link, a radio frequency link, and the like. The main memory 706 and the secondary memory 708 may refer to non-transitory computer readable mediums that may provide data that enables the computer system 700 to implement the method illustrated in FIGS. 6A and 6B.

Various embodiments of the disclosure provide the application server 104 for assessing the performance of the driver 112 of the vehicle 108. The application server 104 may be configured to receive the plurality of primary signals from the vehicle device 106 of the vehicle 108 and the driver device 110 of the driver 112 associated with the vehicle 108. The application server 104 may be further configured to process the plurality of primary signals to generate the plurality of secondary signals. The application server 104 may be further configured to generate the driver profile including at least the plurality of driving parameters and their respective parameter values based on at least the plurality of secondary signals. The application server 104 may be further configured to determine the driver score corresponding to the performance and behavior of the driver 112 based on the parameter values. The application server 104 may be further configured to determine the degree of deviation. The degree of deviation may be determined based on a comparison of the driver score with the baseline threshold value. The application server 104 may be further configured to detect the positive or negative deviation in the performance and behavior of the driver 112 based on the degree of deviation. The application server 104 may be further configured to communicate the driver profile to the driver 112 of the vehicle 108. The driver profile may include the driver score, the degree of deviation, the set of positive or negative feedback, and the one or more action items. The set of positive or negative feedback may be generated in real-time based on the positive or negative deviation, respectively. Further, the one or more action items may be associated with the set of positive or negative feedback. Further, each of the one or more action items may be associated with the time duration for completing each of the one or more action items.

Various embodiments of the disclosure provide a non-transitory computer readable medium having stored thereon, computer executable instructions, which when executed by a computer, cause the computer to execute operations for assessing the performance of the driver 112. The operations include receiving, by the application server 104, the plurality of primary signals from the vehicle device 106 of the vehicle 108 and the driver device 110 of the driver 112 associated with the vehicle 108. The operations further include processing, by the application server 104, the plurality of primary signals to generate the plurality of secondary signals. The operations further include generating, by the application server 104, the driver profile including at least the plurality of driving parameters and their respective parameter values based on at least the plurality of secondary signals. The operations further include determining, by the application server 104, the driver score corresponding to performance and behavior of the driver 112 based on the parameter values. The operations further include determining, by the application server 104, the degree of deviation based on a comparison of the driver score with the baseline threshold value. The operations further include detecting, by the application server 104, the positive or negative deviation in the performance and behavior of the driver 112 based on the degree of deviation. The operations further include communicating, by the application server 104, to the driver 112, the driver profile including the driver score, the degree of deviation, the set of positive or negative feedback, and the one or more action items. The set of positive or negative feedback is generated in real-time based on the positive or negative deviation, respectively. The one or more action items are associated with the set of positive or negative feedback, and each of the one or more action items is associated with the time duration for completing each of the one or more action items.

The disclosed embodiments encompass numerous advantages. Based on the assessed performance, driver profiles are generated for the drivers. Each driver profile includes a driver score, a degree of deviation, a set of positive or negative feedback, and one or more action items. Thus, based on the driver profiles, the drivers can evaluate themselves in real time and accordingly plan for their future rides. Also, the one or more actions items associated with the set of positive or negative feedback are presented to each driver in an online manner and these action items must be executed or completed by each driver within a given time duration. This helps in improving the driving skills and enhancing the driving behavior which may reduce occurrence of unwanted incidents such as accidents. This further helps in improving the drivers' behavior towards customers which may reduce occurrence of unwanted arguments between a driver and a passenger. This further helps in ensuring a high-quality service to the customers while maintaining the morale of the drivers. The overall strategy of the disclosure is to automate performance monitoring, give real-time feedback, reward good behavior, and provide advice and training to steer away from bad behavior.

A person of ordinary skill in the art will appreciate that embodiments and exemplary scenarios of the disclosed subject matter may be practiced with various computer system configurations, including multi-core multiprocessor systems, minicomputers, and mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the disclosure provide, among other features, systems and methods for assessing the performance of the one or more drivers. While various exemplary embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A method, comprising:
receiving, by a server, a plurality of primary signals from a vehicle device of a vehicle and a driver device of a driver associated with the vehicle;
processing, by the server, the plurality of primary signals to generate a plurality of secondary signals;
generating, by the server, a driver profile including at least a plurality of driving parameters and their respective parameter values based on at least the plurality of secondary signals;
determining, by the server, a driver score corresponding to performance and behavior of the driver based on the parameter values;
determining, by the server, a degree of deviation based on a comparison of the driver score with a baseline threshold value;
detecting, by the server, a positive or negative deviation in the performance and behavior of the driver based on the degree of deviation; and
communicating, by the server, to the driver, the driver profile including the driver score, the degree of deviation, a set of positive or negative feedback, and one or more action items, wherein the set of positive or negative feedback is generated in real-time based on the positive or negative deviation, respectively, wherein the one or more action items are associated with the set of positive or negative feedback, and wherein each of the one or more action items is associated with a time duration for completing each of the one or more action items.

2. The method of claim 1, wherein the plurality of primary signals includes at least vehicle dynamics information, vehicle throttle information, brake application information, steering wheel information, vehicle door information, vehicle engine information, in-vehicle communication information, real-time position information, allocation-based call log information, and login and logout information.

3. The method of claim 1, further comprising:
receiving, by the server, from a customer device of a customer, customer feedback corresponding to the performance and behavior of the driver, wherein the customer feedback includes at least one of one or more comments, a rating, or a multimedia recording, and wherein the customer feedback is received for an ongoing ride or a completed ride associated with the vehicle and the driver; and
normalizing, by the server, the customer feedback based on historical customer feedback associated with the customer, wherein the customer feedback is normalized to obtain a normalized feedback signal indicating at least a degree of severity of the customer feedback.

4. The method of claim 3, wherein further comprising updating, by the server, the plurality of secondary signals based on the normalized feedback signal.

5. The method of claim 1, wherein the plurality of secondary signals includes at least driving pattern information, driver's in-vehicle behavior information, customer's in-vehicle behavior information, vehicle's performance information, incident information, allocation-based responsiveness information, and customer satisfaction information.

6. The method of claim 1, further comprising determining, by the sever, the baseline threshold value based on at least one of a type of the vehicle, a geographical region in which the driver is driving the vehicle, working hours of the driver, or historical performance and rating of the driver.

7. The method of claim 1, wherein the set of positive feedback is presented to the driver by using a gamified scoring system,
wherein the one or more action items associated with the set of positive feedback include one or more instructions for advancing to a next score level from a current score level in the gamified scoring system, and
wherein each score level is associated with an offer along with an allotment preference for one or more future rides.

8. The method of claim 1, wherein the one or more action items associated with the set of negative feedback include at least one of one or more warning messages or cool-off periods for future allotments.

9. The method of claim 8, wherein the one or more action items associated with the set of negative feedback further include a suspension for retraining, wherein the retraining includes presentation of one or more video tutorials on the driver device, followed by electronic questionnaires.

10. The method of claim 1, wherein the set of positive or negative feedback is communicated to the driver via a service application running on the driver device, an interactive voice response (IVR) call, or a short message service (SMS).

11. A system, comprising:
a server configured to:
a plurality of primary signals from a vehicle device of a vehicle and a driver device of a driver associated with the vehicle;
process the plurality of primary signals to generate a plurality of secondary signals;
generate a driver profile that includes at least a plurality of driving parameters and their respective parameter values based on at least the plurality of secondary signals;
determine a driver score that corresponds to performance and behavior of the driver based on the parameter values;
determine a degree of deviation based on a comparison of the driver score with a baseline threshold value;
detect a positive or negative deviation in the performance and behavior of the driver based on the degree of deviation; and
communicate, to the driver, the driver profile that includes the driver score, the degree of deviation, a set of positive or negative feedback, and one or more action items, wherein the set of positive or negative feedback is generated in real-time based on the positive or negative deviation, respectively, wherein the one or more action items are associated with the set of positive or negative feedback, and wherein each of the one or more action items is associated with a time duration to complete each of the one or more action items.

12. The system of claim 11, wherein the plurality of primary signals includes at least vehicle dynamics information, vehicle throttle information, brake application information, steering wheel information, vehicle door information, vehicle engine information, in-vehicle communication information, real-time position information, allocation-based call log information, and login and logout information.

13. The system of claim 11, wherein the server is further configured to:
receive, from a customer device of a customer, customer feedback that corresponds to the performance and behavior of the driver, wherein the customer feedback includes at least one of one or more comments, a rating, or a multimedia recording, and wherein the customer feedback is received for an ongoing ride or a completed ride associated with the vehicle and the driver; and
normalize the customer feedback based on historical customer feedback associated with the customer, wherein the customer feedback is normalized to obtain a normalized feedback signal that indicates at least a degree of severity of the customer feedback.

14. The system of claim 13, wherein the server is further configured to update the plurality of secondary signals based on the normalized feedback signal.

15. The system of claim 11, wherein the plurality of secondary signals includes at least driving pattern information, driver's in-vehicle behavior information, vehicle's performance information, incident information, allocation-based responsiveness information, and customer satisfaction information.

16. The system of claim 11, wherein the server is further configured to determine the baseline threshold value based on at least one of a type of the vehicle, a geographical region in which the driver is driving the vehicle, working hours of the driver, or historical performance and rating of the driver.

17. The system of claim 11, wherein the server is further configured to present the set of positive feedback to the driver by use of a gamified scoring system,
wherein the one or more action items associated with the set of positive feedback include one or more instructions to advance to a next score level from a current score level in the gamified scoring system, and
wherein each score level is associated with an offer along with an allotment preference for one or more future rides.

18. The system of claim 11, wherein the one or more action items associated with the set of negative feedback include at least one of one or more warning messages or cool-off periods for future allotments.

19. The system of claim 18, wherein the one or more action items associated with the set of negative feedback further include a suspension to retrain,
wherein the retrain includes presentation of one or more video tutorials on the driver device, followed by electronic questionnaires.

20. The system of claim 11, wherein the server is further configured to communicate the set of positive or negative feedback to the driver via at least one of a service application that runs on the driver device, an interactive voice response (IVR) call, or a short message service (SMS).
